(19) United States
(12) Patent Application Publication
(10) Pub. No.: US 2007/0024387 A1
(43) Pub. Date: Feb. 1, 2007

(54) Rotary signal couplers

(75) Inventors: Serghei Sandacci, Oxford (GB); James E. Gilkes, Banbury (GB)

Correspondence Address: NIXON & VANDERHYE, PC, 901 NORTH GLEBE ROAD, 11TH FLOOR, ARLINGTON, VA, 22203, US

(73) Assignee: SENSOR TECHNOLOGY LTD., Oxon (GB)

(21) Appl. No.: 11/491,085

(22) Filed: Jul. 24, 2006

(30) Foreign Application Priority Data
Jul. 26, 2005 (GB) 0515372.1

(51) Int. Cl. H01P 1/06

(52) U.S. Cl. 333/24 R; 333/261

(57) ABSTRACT

A rotary signal coupler having first and second portions 3a, 3b which are rotatable relative to one another and each have a plurality of pairs of inductive communication elements 34a, 34b and capacitive elements 35a, 36a, 35b, 36b which pairs are chosen to have resonant frequencies compatible with the frequency of the signals to be transferred.

This invention relates to rotary signal couplers which may be used for transferring electrical signals between a stationary structure and a rotating body such as a shaft.

Rotary signal couplers of this general type may be used in a variety of different circumstances. Such couplers can provide radio frequency signal coupling at close range. This type of couplers are generally non-contact devices which utilise non-propagating magnetic fields localised around the transmitting device within the so-called near field range. The near field is conventially defined as λ/10 where λ is the wave length of the propagating wave. One area in which such rotary couplers are used is in the interrogation of surface acoustic wave (SAW) devices which are used to measure torque and strain on rotating shafts. In such circumstances the SAW device is mounted on the shaft, but the associated electronics for excitation and measurement are provided on a stationary structure in the region of the shaft. The use of a rotary coupler allows the application of excitation signals to excite the SAW device and also the reception of the resulting signals which are used to make measurements. The present application relates to rotary couplers themselves rather than a particular use to which they are put and therefore detailed description of such systems is not included in this specification. An example system making use of a SAW device in the measurement of torque and including a rotary coupler can be found in WO91/13832.

Existing rotary couplers have limitations and drawbacks. For example in some cases there can be an overall limit in size in which a particular structure of rotary coupler will function correctly and some other existing rotary couplers are expensive to produce and/or can provide unreliable or inaccurate results.

It is an object of the present invention to provide a rotary coupler which alleviates at least some of the problems associated with the prior art.

According to one aspect of the present invention there is provided a rotary signal coupler comprising first and second portions which are arranged to be rotatable relative to one another, the first portion comprising at least one respective signal communication element having electrical inductance and at least one respective capacitive element having electrical capacitance and being connected in series with the respective signal communication element and the second portion comprising at least one respective signal communication element having electrical inductance and at least one respective capacitive element having electrical capacitance and being connected in series with the respective signal communication element, the coupler being arranged to allow transfer of signals between the communication element on the first portion and the communication element on the second portion.

Generally each communication element will comprise a communication strip provided on the respective portion of the coupler.

The at least one signal communication element and at least one capacitive element of each portion may be connected together in a respective loop.

Typically the first portion of the rotary signal coupler will comprise a respective plurality of signal communication elements which are connected in series with a respective plurality of capacitive elements. Typically the second portion of the rotary signal coupler will comprise a respective plurality of signal communication elements which are connected in series with a respective plurality of capacitive elements.

In such cases the signal communication elements and capacitive elements of each portion may be connected together in series to form a respective loop. The signal communication elements and capacitive elements may be connected alternately in series. By this it is meant that a communication element is connected to a capacitive element which in turn is connected to a signal communication element and so on.

Each end of each signal communication element may be connected to a respective terminal of a respective capacitive element.

Each portion of the coupler may be arranged so that the at least one respective communication element and at least one respective capacitive element together have a predetermined frequency response characteristic. Each portion may be arranged so that the at least one respective communication element and at least one respective capacitive element together have a predetermined resonant frequency.

Each portion can comprise at least one LC resonator. Preferably each portion comprises a plurality of LC resonators connected in series. Here, as is conventional, L stands for an inductor/inductance and C stands for a capacitor/capacitance. The communication element provides inductance and the capacitive element provides capacitance.

Preferably the two portions of the coupler are arranged so that the frequency response characteristic associated with the first portion is substantially the same as that for the second portion.

Preferably the two portions are arranged so that the resonant frequency associated with the first portion is substantially the same as that for the second portion.

Arranging for the frequency response and/or resonant frequency of the two portions to be similar can help provide a tuned device where transmission of signals from one portion to the other is more effective at some frequencies than others.

Each portion may comprise a body portion which carries the respective communication and capacitive elements. Each portion may comprise a piece of circuit board. Each communication element may comprise a portion of track provided on the circuit board. Each capacitive element may comprise at least one portion of track provided on the circuit board.

It will be appreciated that the provision of printed circuit boards (for use in other devices) having typically copper tracks is a standard technology, with the tracks being provided using lithography techniques or so on. The present devices can take advantage of this technology to help keep size and cost down.

The body portion/piece of circuit board may be annular.

The circuit board may be double sided board where track portions are provided on each side of the board.

Each capacitive element may comprise two track portions, one disposed on a first side of the respective board and one disposed on a second side of the respective board. The track portions on either side of the board may be arranged in register with one another.

The at least one communication element of the first portion of the coupler may comprise a track disposed on a side of the respective piece of circuit board which faces the second portion of the coupler and the at least one communication element of the second portion of the coupler may comprise a track disposed on a side of the respective piece of circuit board which faces the first portion of the coupler.

An end of at least one of the tracks forming a capacitive element may be shaped to reduce the electric field generated at the region of the end of the track.

The at least one track acting as a communication element may be disposed radially outwards of the or each track of the at least one capacitive element.

A first end of the track of each communication element may be connected to a track portion of a respective capacitive element that is disposed on the same side of the circuit board as the communication element and a second end of the track of each communication element may be connected to a track portion of a respective capacitive element that is disposed on the opposite side of the circuit board than the communication element. Appropriate connections may be provided through the board.

In some embodiments the capacitive elements and/or communication elements may comprise external or discrete components mounted to a body portion of the respective portion of the coupler.

Generally one portion of the coupler will be arranged to act as a stator and the other portion will be arranged to act as a rotor. The rotor may be subjected to high speed rotation in use. This means that the use of external or discrete components on the rotor is less preferred than on the stator.

The signals to be transferred from one portion of the coupler to the other may, for example, be data carrying signals or power signals—ie the coupler may be used to transmit power from a stationary part to a rotating part.

The coupler may be arranged to act as a near field coupler such that there is no significant propagation of electromagnetic energy away from the coupler.

Preferably the arrangement of the inductive elements and capacitive elements on the two portions of the coupler are symmetrical with respect to each other from the electromagnetic point of view. The arrangement of the inductive elements and capacitive elements on the two portions of the couple may be dimensionally symmetrical with respect to each other.

In one set of embodiments, the same number of communication elements may be provided on the first portion as are provided on the second portion. The same number of capacitive elements may be provided on the first portion as are provided on the second portion.

Asymmetrical arrangements may also be used. There may be differing numbers of communication elements and/or capacitive provided on the first and second portions.

The number of communication elements provided on each portion may be chosen to optimise performance. The length of each communication element may be chosen in dependence on the wavelength of the signals to be transferred from one element to the other. The length of each communication element may be chosen so as to not exceed one quarter of the wavelength of the signals to be transferred.

A Faraday shield may be provided between the two portions of the coupler.

According to another aspect of the present invention there is provided measurement apparatus comprising a sensor mounted on a shaft journalled for rotation relative to a structure, a control unit mounted on the structure and a rotary signal coupler of the type defined above for allowing communication between the sensor and the control unit.

The measurement apparatus may, for example, be for measuring torque or rotary strain or temperature.

The sensor may, for example, comprise a surface acoustic wave (SAW) device.

According to another aspect of the present invention there is provided power supply apparatus for supplying power to a device mounted on a shaft journalled for rotation relative to a structure, the apparatus comprising a power source available at the structure and a rotary signal coupler of the type defined above for allowing communication of power from the power source to the device mounted on the shaft.

According to another aspect of the present invention there is provided torque measurement apparatus comprising a torque sensor mounted on a shaft journalled for rotation relative to a structure, a control unit mounted on the structure and a rotary signal coupler for allowing communication between the sensor and the control unit, the rotary coupler comprising first and second portions which are arranged to be rotatable relative to one another, the first portion being mounted on the structure and comprising at least one respective signal communication element having electrical inductance and at least one respective capacitive element having electrical capacitance and being connected in series with the respective signal communication element and the second portion being mounted on the shaft and comprising at least one respective signal communication element having electrical inductance and at least one respective capacitive element having electrical capacitance and being connected in series with the respective signal communication element, the coupler being arranged to allow transfer of signals between the communication element on the first portion and the communication element on the second portion.

According to a further aspect of the present invention there is provided a method of transferring signals between a structure and a shaft arranged for rotation relative to the structure comprising the step of using a rotary signal coupler comprising first and second portions which are arranged to be rotatable relative to one another, the first portion comprising at least one respective signal communication element having electrical inductance and at least one respective capacitive element having electrical capacitance and being connected in series with the respective signal communication element and the second portion comprising at least one respective signal communication element having electrical inductance and at least one respective capacitive element having electrical capacitance and being connected in series with the respective signal communication element, and the coupler being arranged to allow transfer of signals between the communication element on the first portion and the communication element on the second portion.

Embodiments of the present invention will now be described, by way of example only, with reference to the accompanying drawings in which:

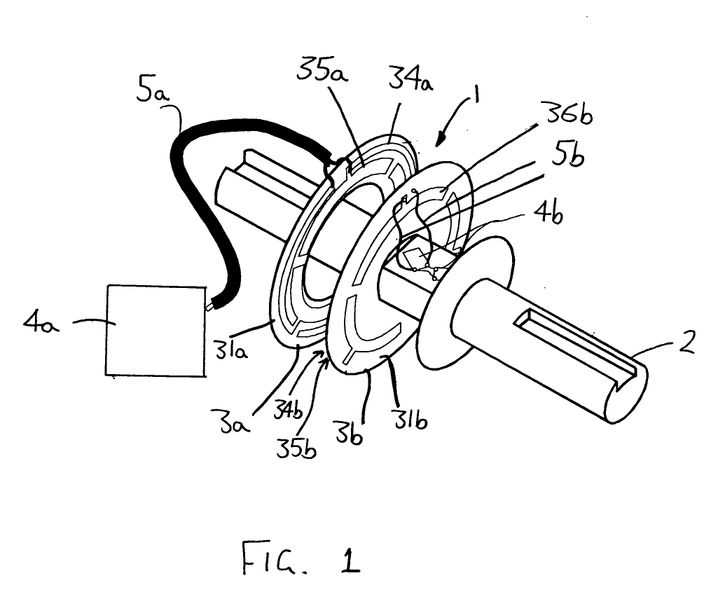

FIG. 1 schematically shows a measurement apparatus including a rotary coupler mounted on a shaft;

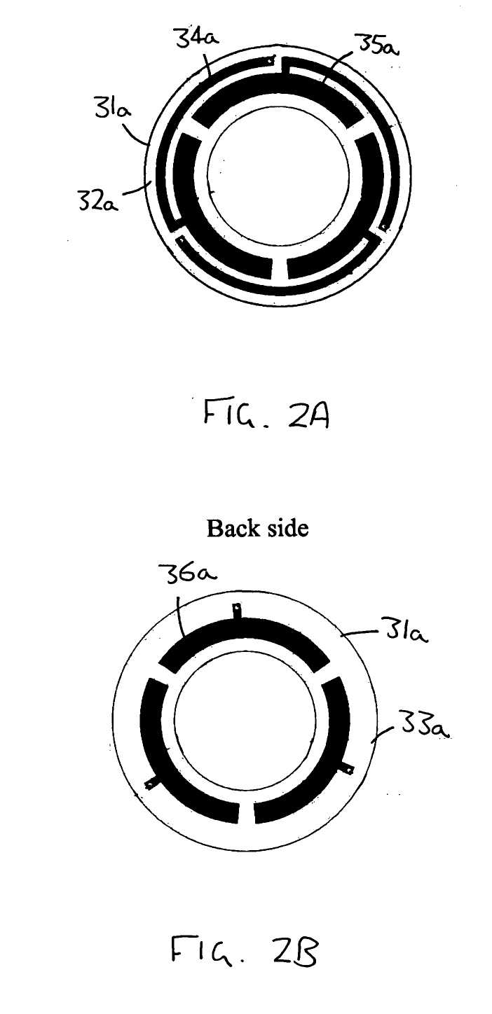

FIG. 2A shows a first side of one of the portions of the rotary coupler shown in FIG. 1;

FIG. 2B shows the other side of the portion of the rotary coupler shown in FIG. 2;

FIG. 3 is a simplified equivalent circuit diagram representing the electrical nature of one of the portions of the coupler shown in FIGS. 1 and 2;

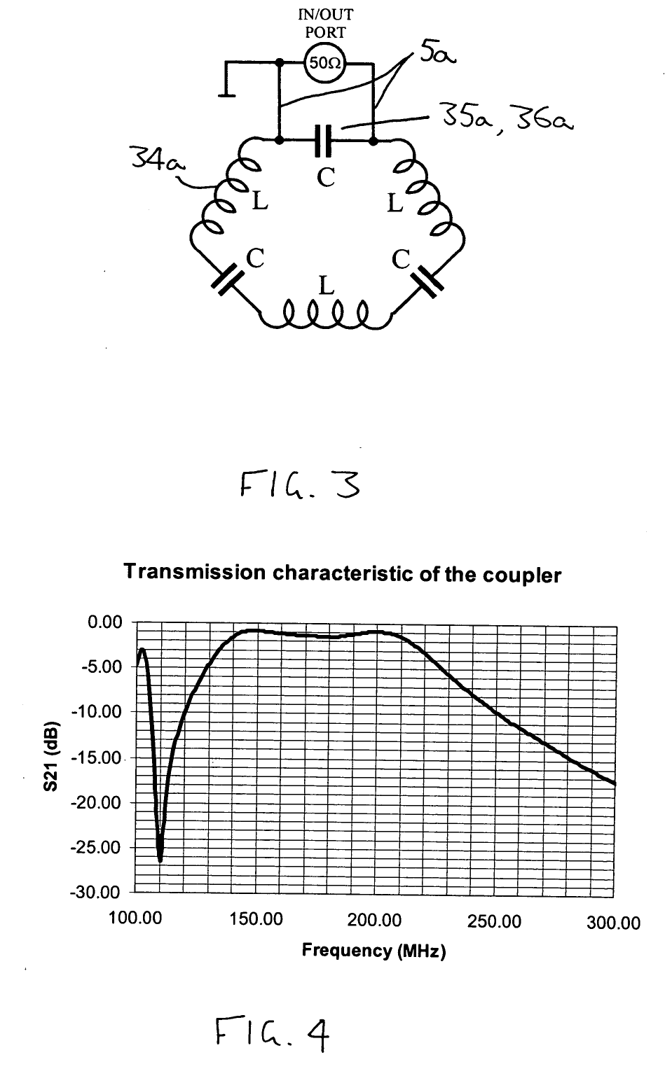

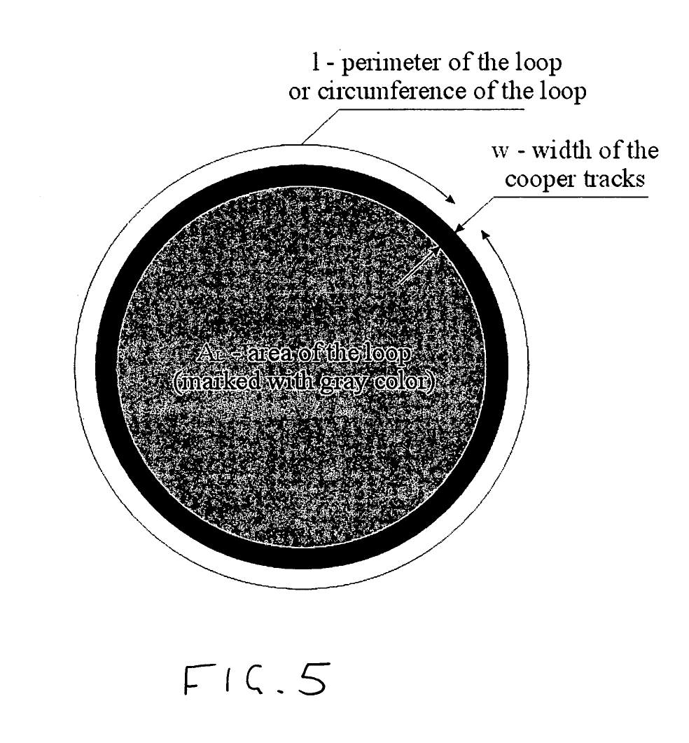

FIG. 4 shows a plot of the transmission characteristic of the rotary coupler shown in FIGS. 1 and 2;

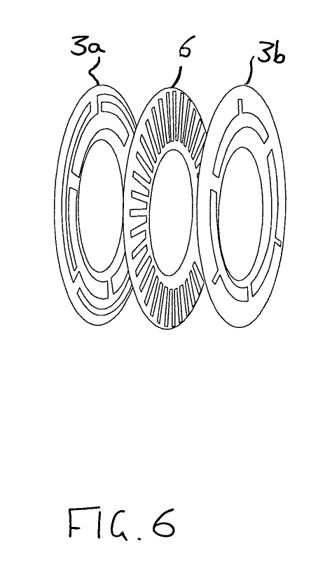

FIG. 5 shows an explanatory diagram which is useful in understanding a method used to choose parameters when designing a coupler;

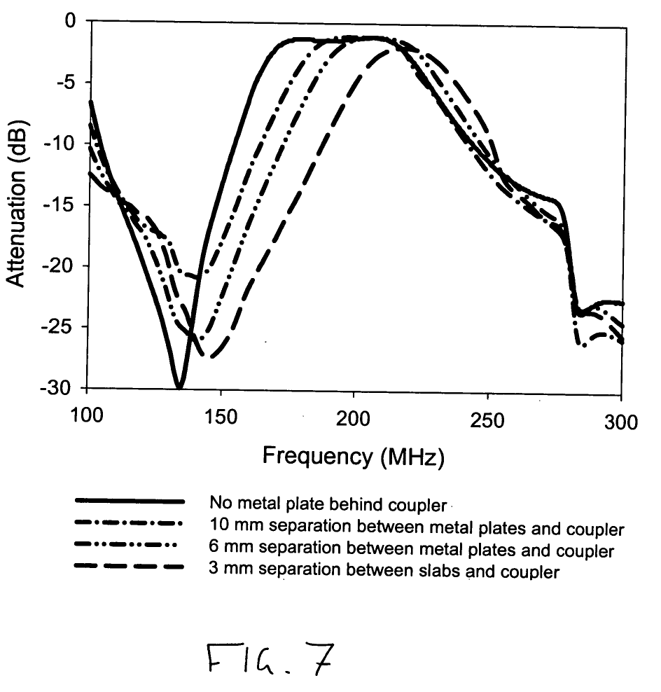

FIG. 6 schematically shows part of an alternative form of rotary coupler; and

FIG. 7 is a plot showing the effect on transmission characteristics which is caused by placing metal plates in the region of the coupler.

FIG. 1 shows a measurement apparatus including a rotary coupler 1 mounted with respect to a shaft 2. The shaft 2 is journaled for rotation relative to structure (not shown). The rotary coupler 1 comprises two portions 3a and 3b. A first of these portions 3a is fixed to the structure (not shown) and therefore is not arranged for rotation. On the other hand the second portion 3b is mounted to the shaft 2 and is arranged to rotate with the shaft 2.

This second portion 3b of the coupler 1 is electrically connected by suitable wires 5b to sensors, in this case to SAW devices 4b, mounted on the shaft. Similarly the first portion 3a of the rotary coupler 1 is connected via appropriate wires 5a to associated control and measurement circuitry 4a used with the sensors 4b. In essence the rotary coupler 1 allows the communication of signals between the sensors 4b and the related control and measurement circuitry 4a.

The two portions 3a, 3b of the rotary coupler 1 are generally the same as each other and in fact may be identical. The two portions 3a, 3b of the rotary coupler are arranged in a face to face relationship with a relatively small spacing therebetween.

Typically, the spacing between the two portions 3a, 3b of the coupler will be smaller than one tenth of the wave length of the signals to be transmitted.

This ensures that the rotary coupler 1 is able to operate in the near field range. The optimum spacing in between the two portions 3a, 3b of the rotary coupler 1 may be determined empirically for any particular design used.

FIGS. 2A and 2B show the first portion 3a of the rotary coupler in more detail. It will be noted that the second portion 3b of the rotary coupler 1 is substantially the same as the first portion 3a. Therefore where both of the portions 3a, 3b can be seen, for example in FIG. 1, the same numerical reference figure is used to indicate the corresponding portions with “a” following that numeral in respect of the first portion 3a and “b” following that numeral in respect of the second portion 3b.

Each portion 3a, 3b of the coupler 1 comprises a disc like annular piece of circuit board material 31a, 31b which is typically of fibreglass material. This annular piece of circuit board material 31a, 31b acts as a main body of that portion 3a, 3b of the rotary coupler 1.

In the case of the first portion 3a, the annular portion of circuit board material 31a is arranged so that the shaft 2 may pass through the central aperture of the annulus so as to allow free rotation of the shaft 2 relative to the piece of circuit board material 31a. In the case of the second piece of circuit board material 31b, the shaft 2 still passes through the central aperture, but the piece of circuit board material 31a is secured to the shaft 2 at this central aperture or bore.

A first side 32a of the first portion 3a is shown in FIG. 2A and a second side 33a is shown in FIG. 2B. The first side 32a can be considered as the front of the coupler portion 3a. The two coupler portions 3a, 3b are provided on the shaft 2 so that the front sides of the two portions 3a, 3b face each other.

In the present embodiment the main features of each of the portions 3a, 3b of coupler are provided by metalised tracks provided on the two surfaces of the circuit board substrate 31a, 31b. These metalised tracks are provided on the circuit board substrates 31a, 31b in the conventional way using lithography techniques. The tracks are typically copper but can be a suitable electrically conductive material for example, gold.

On the first side of the coupler portion 3a there are provided three arcuate transmission lines 34a. These transmission lines 34a act as communication elements. Each of the transmission lines 34a are of substantially the same length as one another. In this embodiment the transmission lines 34a each represent approximately 120° of arc. Connected in series between each transmission line 34a is a capacitive of element each of which comprises a first portion of track 35a provided on the first side 32a of the piece of circuit board 31a and a second portion of track 36a provided on the second side 33a of the piece of circuit board 31a and in register with the first portion 35a. Thus there are three capacitive elements each comprising respective first and second track portions 35a, 36a. As can be seen by considering FIGS. 2A and 2B, a first end of each of the transmission lines 34a is connected to a first track portion 35a of one of the capacitive elements whilst the other end of each transmission line 34a is connected through the circuit board material 31a to the respective other track portion 36a of the respective capacitive element.

It will be seen that in this embodiment the tracks 35a, 36a forming the capacitive elements are disposed radially inwards of the transmission line tracks 34a.

Referring back now to FIG. 1 it can be seen that the wires 5a connecting the first portion 3a of the coupler 1 to the interrogation and measurement equipment 4a are connected across one of the capacitive elements 35a, 36a of the first portion 3a whereas the wires 5b connected to the SAW devices 4b are connected across one of the capacitive elements 35b, 36b of the second portion 3b of the coupler 1.

In operation as the two portions of the coupler 3a, 3b rotate relative to one another signals from the control circuitry 4a applied to the first portion 3a are transmitted from the transmission lines 34a on the first portion 3a and picked up by the transmission lines 34b on the second portion 3b. Similarly signals can travel in the opposite direction, i.e. from the transmission lines 34b on the second portion 3b to those 34a on the first portion 3a. The electrical signals in the transmission lines 34a, 34b are transmitted across the gap between the portions 3a, 3b as inductive or near field magnetic signals.

FIG. 3 shows a simplified equivalent circuit of the first portion 3a of the rotary coupler as shown in FIGS. 2A and 2B (the equivalent circuit for the second portion 3b would be the same). Here it can be seen that each transmission line 34a is considered to act as an inductor whereas the capacitive elements 35a, 36a each act as a capacitor thus forming three LC resonators connected in series in a ring.

This structure of the coupler portion 3a, 3b has advantages.

First of all it means that the length of each transmission line 34a may be chosen bearing in mind the wave length of the signals which are to be transmitted. In particular it is desirable if the length of each transmission line 34a is no longer than one quarter of the wave length of the signals which are to be transmitted from one portion of the coupler 3a to the other portion 3b. This is important to suppress phase and/or attenuation variation due to cycling aberration which is a problem with existing rotary couplers. The connection of the sensors 4b and interrogation and measurement circuitry 4a across one of the capacitive elements 35a, 36a is advantageous as it reduces the influence of the connecting cable and the impedance of the transmitter/receiver on the operation of the coupler 1.

In alternatives the connections to the coupler portions 3a, 3b may be different, that is the connections need not be across one of the capacitive elements 35, 36. An input connector can be in series with the LC resonators.

The provision of the capacitive elements 35a, 36a helps to distribute the electric field between the ends of the transmission line portions 34a. Without the capacitors there would tend to be a bunching of electric field between the ends of the tracks. The ends of the tracks 35a, 36a of the capacitive elements may be shaped, in alternatives, so as to help distribute the electric field which will tend to exist between the ends of those tracks 35a, 36a on both sides of the circuit board 31a.

Moreover, as alluded to above, the provision of both inductive elements in the form of the transmission lines 34a and capacitive elements 35a, 36a means that each portion of the coupler 3a, 3b acts as a resonator. This means that the transmission characteristics of the coupler 1 are frequency dependent. The attenuation caused by a practical coupler 1 produced by the applicants is illustrated in a plot shown in FIG. 4. From this it can be seen that the coupler gives very low attenuation over a range of frequencies between 150 Mhz and 200 Mhz. This particular frequency characteristic is determined by the structure of the portions of the coupler 3a, 3b and in particular the values of the inductance and in capacitance of the transmission lines 34a and capacitive elements 35a, 36a. The performance of the coupler 1 is influenced by the resonance characteristics of both portions of the coupler 3a, 3b. Therefore these portions should be designed so as to have substantially the same frequency characteristics in order to achieve maximum efficiency.

In the present case, the coupler 1 whose transmission characteristic is shown in the plot of FIG. 4 was designed to operate at a transmission frequency of 200 Mhz. This is a useful frequency where SAW devices are being used as sensors 4b since this is one frequency at which commercially used SAW devices operate. However it is possible to produce couplers 1 which are tuned to operate at different frequencies. For example couplers may be produced which are arranged to operate effectively at any of the license-free Industrial, Scientific & Medical (ISM) bands including the 418-434 Mhz range, the 860-920 Mhz range, the 2.4-2.5 Ghz range etc. It will be appreciated that due to the resonant nature of the coupler 1 it tends to act as a band pass filter as well as a coupler. This means that for example, noise outside of the band pass range will be suppressed.

It should be noted that the number of transmission lines 34a, 34b chosen for each portion of the coupler 1 can be different from the three transmission lines 34a used in the present embodiment. However, preferably there are the same number of transmission lines 34a, 34b on each portion of the coupler 3a, 3b. In choosing the number of transmission lines 34a, 34b to be used the physical size of the coupler 1 will be relevant as will the wave length of the signals to be transmitted. Thus if a larger diameter shaft 2 is to be used this will tend to drive towards the selection of more transmission lines 34a, 34b to ensure that the length of the transmission lines 34a, 34b remains relatively small compared with the wavelength of the signals to be transmitted.

The coupler shown in FIGS. 1, 2A and 2B and the practical example used in generating the transmission characteristic plot shown in FIG. 4 was one which was designed to use with a shaft 2 having a diameter of 100 mm. The present technique is suitable however, for use with shafts having a wide range of diameters. As mentioned above, as the diameter of the shaft 2 goes up, this will call for more portions of transmission line 34a to be provided. This in turn will mean that more resonators will be used. It has been found that as the number of resonators is increased, the Q of the device decreases and the losses increase. For example in a device which achieved an attenuation of 0.8 db using three tracks, the losses became 3 db if nine transmission line portions were used. It is believed that systems using up to say 10 or 15 portions of transmission line 34a should give reasonable performance using the same general layout as that shown in FIGS. 2A and 2B.

It will be noted that the transmission lines 34a in the present embodiment do not have a ground plane provided on the opposite side of the circuit board substrate 31a. This allows the generation of circular magnetic fields more effectively.

The formation of capacitive elements using capacitor plates formed by tracks 35a and 36a as in the present embodiment is particularly attractive in terms of cheapness of manufacture and robustness. In some cases, however, it might be preferable to provide external capacitor components which could be connected between the transmission lines 34a. This might be useful for example, in situations where there was limited space and suitable capacitance values could not be achieved using the technique of providing plates 35a, 36a in the forms of tracks on the circuit board material 31a.

The transmission lines, or communication elements may also be provided in a different way than as tracks deposited on a circuit board substrate—these might be external/discrete components.

To make the coupler tuneable the discrete communication element can be made, for example, from amorphous ferromagnetic material sensitive to the applied magnetic field. Some ferromagnetic materials, like amorphous wires with circumferential anisotropy of the composition Co₆₈Fe₄Si₁₅B₁₃ are very sensitive to the external magnetic field and may change inductance when magnetic field in a certain direction is applied. This property can be used for developing tuneable LC-resonant circuits and hence resonant couplers.

It is preferable that the provision of transmission lines 34a and capacitive elements 35a, 36a are symmetrical between the two portions 3a and 3b. However, it has been found that a coupler will function where, for example, there are three transmission lines 34a on one portion and four transmission lines on the other portion. Furthermore, it is the electromagnetic symmetry of the two portions 3a, 3b which is important. Therefore, if circumstances dictate the physical arrangement of one portion 3a may differ from the other portion 3b. For example, it might be preferable to provide external components on the first portion 3a which is static, and thus less susceptible to external components becoming detached.

The following explains a process which may be followed in determining suitable design parameters for a coupler 1 to be used in transmitting signals at a predetermined frequency. FIG. 5 schematically shows a loop of material T which might be used as a transmission line in a single piece. A first stage of the process is to calculate the inductance of such an annular track T. This inductance L is given by the following equation:

$$L = \frac{μ}{2 π} l \cdot ln ( \frac{8 {A}_{L}}{lw} )$$

where μ—is permeability of air (4π×10⁻⁷ H/m), l—is a perimeter of the loop (circumference) [m], A_{L}—is an area of the loop [m²], w—is a width of the copper track [m]. The parameters l, A_{L} and w are shown in FIG. 5.

After this the number N of resonators has to be chosen. In choosing the number of resonators the idea of ensuring that the length of each transmission line 34a is kept below one quarter of the wave length should be borne in mind as well as the fact that an increase in the number of resonators tends to increase losses.

Once the number of resonators N is known the inductance Lᵢ of each length of transmission line 34a can be calculated using the following equation:

$${L}_{i} = \frac{L}{N}$$

Then the required capacitance C of each resonator can be calculated for given frequency (ƒ) of signals to be transmitted and inductance (Lᵢ), using the relation

$$f = \frac{1}{2 π \sqrt{LC}}$$

Then if lengths of track 35a, 36a are to be used to provide capacitance an effective area A_{c} the capacitive plates can be calculated using the following relationship:

$$C = \frac{{ɛɛ}_{0} {A}_{c}}{d}$$

where ε₀—is permittivity of air (8.85×10⁻¹² F/m), ε—is permittivity of dielectric material used (for FR-4 (circuit-board substrate), ε=4.7), d—is a thickness of the dielectric insulator [m].

Once this area A_{c} is known the parameters can be optimised to maximise circular symmetry around the centre of the annular piece of circuit board 31a. The tracks for the transmission lines 34a and capacitive elements 35a and 36a are preferably constructed as arcs around the centre and bearing this in mind suitable shapes and sizes for the tracks can be calculated.

After following these steps the design of the coupler may be optimised empirically.

FIG. 6a schematically shows part of an alternative form of coupler 1. Here there are again two portions of coupler 3a, 3b which are the same as that described above, but disposed in the space between these two portions of coupler 3a, 3b is a Faraday shield 6. The Faraday shield 6 comprises of another piece of circuit board material with tooth-like pattern of copper tracks provided thereon. The provision of a Faraday shield portion 6 between the two coupler portions 3a, 3b can help to further reduce phase and attenuation variations in the coupler 1. The provision of a Faraday shield is useful in eliminating variations in electrical fields in the near field region. The Faraday shield may be stationary or rotate with the shaft.

It has been found that placing metal in the region of the coupler 1 affects its performance. If such pieces of metal (which for example might be the casing of a commercial transducer housing the coupler 1) are provided asymmetrically with regards to the coupler 1, then a decrease in efficiency is observed. However, if the pieces of metal are arranged symmetrically around the coupler 1, then a far less significant drop off in efficiency is seen, but rather a shift in resonant frequency of the coupler is observed. A plot shown in FIG. 7 shows the shift in transmission characteristics of the coupler 1 as pieces of metal plate are symmetrically introduced in the region of the coupler. It can be seen that as these pieces of metal plate approach closer to the coupler itself, the resonant frequency or band pass of the coupler shifts and there is a reduction in transmission efficiency.

Thus, in designing a whole product incorporating a coupler 1 of the present kind, the proximity to other pieces of metal should be taken into account. It should, in principle, be possible to design a coupler having a nominal frequency characteristic which is skewed away from the desired frequency such that when the coupler is put next to be pieces of metal which are required as forming part of a whole installation, the frequency characteristic is shifted so as to match the required frequency for transmission.

Couplers of the present kind allow very low insertion to be achieved. It may be that the couplers, in at least some circumstances, can be considered to act as a new type of “left hand material” that amplifies near field radiation and significantly reduces losses.

It should be noted that the dimensions of the coupler are easily expandable.

1. A rotary signal coupler comprising first and second portions which are arranged to be rotatable relative to one another, the first portion comprising a respective plurality of signal communication elements having electrical inductance and a respective plurality of capacitive elements having electrical capacitance and being connected in series with the respective plurality of signal communication elements and the second portion comprising a respective plurality of signal communication elements having electrical inductance and a respective plurality of capacitive elements having electrical capacitance and being connected in series with the respective plurality of signal communication elements, the coupler being arranged to allow transfer of signals between the communication elements on the first portion and the communication elements on the second portion.

2. A rotary signal coupler according to claim 1 in which the signal communication elements and capacitive elements of each portion are connected together in series to form a respective loop.

3. A rotary signal coupler according to claim 2 in which the signal communication elements and capacitive elements are connected alternately in series.

4. A rotary signal coupler according to claim 1 in which each portion comprises a body portion which carries the respective communication and capacitive elements, each body portion comprising a piece of circuit board and each communication element comprising a portion of track provided on the circuit board and each capacitive element comprising at least one portion of track provided on the circuit board.

5. A rotary signal coupler according to claim 4 in which the circuit board is double sided board where track portions are provided on each side of the board.

6. A rotary signal coupler according to claim 5 in which each capacitive element comprises two track portions, one disposed on a first side of the respective board and one disposed on a second side of the respective board.

7. A rotary signal coupler according to claim 4 in which an end of at least one of the tracks forming a capacitive element is shaped to reduce the electric field generated at the region of the end of the track.

8. A rotary signal coupler according to claim 4 in which at least one of the communication elements of the first portion of the coupler comprises a track disposed on a side of the respective piece of circuit board which faces the second portion of the coupler and at least one of the communication elements of the second portion of the coupler comprises a track disposed on a side of the respective piece of circuit board which faces the first portion of the coupler.

9. A rotary signal coupler according to claim 4 in which the at least one track acting as a communication element is disposed radially outwards of at least one track of the at least one capacitive element.

10. A rotary signal coupler according to claim 4 in which a first end of the track of each communication element is connected to a track portion of a respective capacitive element that is disposed on the same side of the circuit board as the communication element and a second end of the track of each communication element is connected to a track portion of a respective capacitive element that is disposed on the opposite side of the circuit board than the communication element.

11. A rotary signal coupler according to claim 10 in which appropriate connections are provided through the board.

12. A rotary signal coupler according to claim 1 in which each portion of the coupler is arranged so that at least one of the respective plurality of communication elements and at least one of the respective plurality of capacitive elements together have a predetermined frequency response characteristic.

13. A rotary signal coupler according to claim 12 in which each portion is arranged so that the at least one respective communication element and the at least one respective capacitive element together have a predetermined resonant frequency.

14. A rotary signal coupler according to claim 12 in which the two portions of the coupler are arranged so that the frequency response characteristic associated with the first portion is substantially the same as that for the second portion.

15. A rotary signal coupler according to claim 13 in which the two portions are arranged so that the resonant frequency associated with the first portion is substantially the same as that for the second portion.

16. A rotary signal coupler according to claim 1 in which the arrangement of the inductive elements and capacitive elements on the two portions of the coupler are symmetrical with respect to each other from the electromagnetic point of view.

17. A rotary signal coupler according to claim 1 in which the arrangement of the inductive elements and capacitive elements on the two portions of the coupler are dimensionally symmetrical with respect to each other.

18. A rotary signal coupler according to claim 1 in which the same number of communication elements are provided on the first portion as are provided on the second portion and the same number of capacitive elements are provided on the first portion as are provided on the second portion.

19. A rotary signal coupler according to claim 1 in which the length of each communication element is chosen in dependence on the wavelength of the signals to be transferred from one element to the other.

20. A rotary signal coupler according to claim 19 in which the length of each communication element is chosen so as to not exceed one quarter of the wavelength of the signals to be transferred.

21. A rotary signal coupler according to claim 1 in which a Faraday shield is provided between the two portions of the coupler.

22. A rotary signal coupler according to claim 1 which is arranged for transmitting power from a stationary part to a rotating part.

23. Measurement apparatus comprising a sensor mounted on a shaft journalled for rotation relative to a structure, a control unit mounted on the structure and a rotary signal coupler according to claim 1 for allowing communication between the sensor and the control unit.

24. Measurement apparatus according to claim 23 which is for measuring one of torque, rotary strain and temperature.

25. Measurement apparatus according to claim 23 in which the sensor comprises a surface acoustic wave (SAW) device.

26. Power supply apparatus for supplying power to a device mounted on a shaft journalled for rotation relative to a structure, the apparatus comprising a power source available at the structure and a rotary signal coupler according to claim 1 for allowing communication of power from the power source to the device mounted on the shaft.

27. A method of transferring signals between a structure and a shaft arranged for rotation relative to the structure comprising the step of using a rotary signal coupler comprising first and second portions which are arranged to be rotatable relative to one another, the first portion comprising a respective plurality of signal communication elements having electrical inductance and a respective plurality of capacitive elements having electrical capacitance and being connected in series with the respective plurality of signal communication elements and the second portion comprising a respective plurality of signal communication elements having electrical inductance and a respective plurality of capacitive elements having electrical capacitance and being connected in series with the respective plurality of signal communication elements, and the coupler being arranged to allow transfer of signals between the communication elements on the first portion and the communication elements on the second portion.

28. A rotary signal coupler comprising first and second portions which are arranged to be rotatable relative to one another, the first portion comprising a respective plurality of signal communication elements having electrical inductance and a respective plurality of capacitive elements having electrical capacitance and being connected in series in a loop with the respective plurality of signal communication elements so that each capacitive element is connected to two adjacent communication elements around the loop and each capacitive element forms a resonator with at least one of the adjacent communication elements and the second portion comprising a respective plurality of signal communication elements having electrical inductance and a respective plurality of capacitive elements having electrical capacitance and being connected in series in a loop with the respective plurality of signal communication elements so that each capacitive element is connected to two adjacent communication elements around the loop and each capacitive element forms a resonator with at least one of the adjacent communication elements, the coupler being arranged to allow transfer of signals between the plurality of communication elements on the first portion and the plurality of communication elements on the second portion.

29. A rotary signal coupler according to claim 1 in which each signal communication element is electrically separated from each adjacent signal communication element by a respective capacitive element.
